(19) United States
(12) Patent Application Publication
(10) Pub. No.: US 2010/0122066 A1
(43) Pub. Date: May 13, 2010

(54) INSTRUCTION METHOD FOR FACILITATING EFFICIENT CODING AND INSTRUCTION FETCH OF LOOP CONSTRUCT

(75) Inventor: Michael A. Fischer, San Antonio, TX (US)

Correspondence Address: ZAGORIN O'BRIEN GRAHAM LLP (115), 7600B N. CAPITAL OF TEXAS HWY., SUITE 350, AUSTIN, TX, 78731-1191, US

(73) Assignee: FREESCALE SEMICONDUCTOR, INC., Austin, TX (US)

(21) Appl. No.: 12/269,614

(22) Filed: Nov. 12, 2008

(51) Int. Cl. G06F 9/38; G06F 9/312

(52) U.S. Cl. 712/205; 712/241; 712/E09.033; 712/E09.058

(57) ABSTRACT

Instruction set techniques have been developed to identify explicitly the beginning of a loop body and to code a conditional loop-end in ways that allow a processor implementation to efficiently manage an instruction fetch buffer and/or entries in an instruction cache. In particular, for some computations and processor implementations, a machine instruction is defined that identifies a loop start, stores a corresponding loop start address on a return stack (or in other suitable storage) and directs fetch logic to take advantage of the identification by retaining in a fetch buffer or instruction cache the instruction(s) beginning at the loop start address, thereby avoiding usual branch delays on subsequent iterations of the loop. A conditional loop-end instruction can be used in conjunction with the loop start instruction to discard (or simply mark as no longer needed) the loop start address and the loop body instructions retained in the fetch buffer or instruction cache.

### BACKGROUND

1. Field

This disclosure relates generally to data processing systems, and more specifically, to processor implementations and instruction techniques for representing a loop construct in machine code and executing same in a data processing system.

2. Related Art

Processor designs routinely provide instruction-level mechanisms that may be used to encode loop constructs. For example, many generations of processors have supported loop constructs in the conventional way, i.e., using a control transfer instruction at loop end (often as a conditional or otherwise predicated branch) to branch backward to a first instruction of the loop body code. While programming languages typically present syntactic features that a programmer (and a compiler) can use to identify both the beginning and the end of a loop in source code, there is typically no explicit coding in the stream of machine instructions actually fetched and executed by a processor for both loop beginning and loop end. Unlike the source forms familiar to programmers, machine or assembly language forms of loop code generated by compilers typically include machine instructions for any necessary pre-loop initialization and then drop directly into the sequence of machine instructions that constitute the loop body. As a result, entry into the loop is often unknown (and indeed unrecognizable) to instruction processing and fetch logic at least until the loop is closed by execution of the branch backward to the first instruction of loop body code.

Accordingly, for some computations and in some processor implementations, successive iterations through the loop may incur non-sequential instruction fetch overhead. Although non-deterministic mechanisms such as branch prediction may be suitable in some processor implementations, those mechanisms may not always be attractive, particularly when embedded, real-time applications are involved. In addition, for some computations and in some processor implementations, squandering coding space within an iteratively executed loop body to specify a backward branch target (e.g., using a full instruction pointer-width branch target) may exacerbate problems and even preclude use of otherwise attractive low overhead looping constructs.

### BRIEF DESCRIPTION OF THE DRAWINGS

The present invention may be better understood, and its numerous objects, features, and advantages made apparent to those skilled in the art by referencing the accompanying drawings.

FIGS. 1 and 2 are respective block diagrams of a general purpose and embedded-type data processing systems in accordance with some embodiments of the present invention.

FIG. 3 is a block diagram that illustrates functional units of a switch on event multithreading (SOEMT) type embedded processor-based system in which techniques in accord with the present invention may be practiced and illustrated.

FIG. 4 is a flowchart that illustrates operations performed by processor upon execution of a BEGIN-type loop delimiting instruction, wherein instruction semantics are in accord with certain illustrative embodiments of the present invention.

FIG. 5 is a flowchart that illustrates operations performed by processor upon execution of a LOOP-type loop delimiting instruction, wherein instruction semantics are in accord with certain illustrative embodiments of the present invention.

FIGS. 6A, 6B and 6C illustrate loop containing code snippets in a way that highlights operation of some embodiments of the present invention and contrasts certain conventional approaches.

FIG. 7 illustrates selected elements of a processor core in connection with execution of BEGIN- and LOOP-type loop delimiting instruction in accordance with some embodiments of the present invention.

### DETAILED DESCRIPTION

Instruction set techniques have been developed to explicitly identify the beginning of a loop body and to code a conditional loop-end in ways that allow a processor implementation to manage efficiently an instruction fetch buffer and/or entries in an instruction cache. In particular, for some computations and processor implementations, a machine instruction is defined that identifies a loop start, stores a corresponding loop start address on a return stack (or in other suitable storage) and directs fetch logic to take advantage of the identification by retaining in a fetch buffer or instruction cache the instruction(s) beginning at the loop start address, thereby avoiding usual branch delays on subsequent iterations of the loop. A conditional loop-end instruction can be used in conjunction with the loop start instruction to discard (or simply mark as no longer needed) the loop start address and the loop body instructions retained in the fetch buffer or instruction cache.

For some computations and/or processor implementations, such techniques can be employed to reduce non-sequential instruction fetch overhead in loops. In some embodiments and for certain classes of computations, the ability to deterministically achieve such reductions using techniques described herein may be attractive. In some embodiments, instruction techniques that separate specification of branch target address from invocation of a loop closing branch may also improve code density and can allow some computations to exploit better fixed- or limited-size architectural constructs such as fetch buffers.

For concreteness of description, we focus on certain illustrative loop-delimiting machine instructions that interact with a return address stack and fetch logic of an embedded-type processor that implements a switch on event multithreading (SOEMT) execution model. Of course, embodiments of the present invention are not limited to the illustrated machine instructions, to embedded-type processors or to any particular execution model, multithreaded or otherwise. For generality, the illustrated machine code implements an ordinary, unbounded loop that may nest (or be nested within) other loops or control constructs. However, based on the description herein persons of ordinary skill in the art will appreciate applications of the invented techniques to other loops or control constructs.

In some embodiments, a BEGIN instruction causes the next instruction address (i.e., the address of the first instruction of a loop body) to be pushed onto a return address stack maintained for a particular thread. A subsequently encountered LOOP instruction tests a condition or predicate, whereupon for some results, the LOOP instruction copies the value at top of the return address stack to the program counter (thereby iterating), and for a loop exit case, pops/discards the top value from the return address stack. The BEGIN instruction also directs fetch logic to retain at least the first instruction of a loop body (e.g., in a fetch buffer that, in some embodiments, may be thread- or context-specific), while the LOOP instruction, in the loop exit case, releases the instruction(s) previously retained by the fetch logic. In some embodiments, further loop body instructions (possibly an entire loop body) may be retained and released based on execution of BEGIN and LOOP instructions.

Techniques described herein have broad applicability to other loop constructs and to other processor designs, but will be understood and appreciated by persons of ordinary skill in the art in the illustrated context of BEGIN and LOOP instructions and the utility of such instructions for generally deterministic loop performance on an illustrative embedded-type SOEMT processor. Accordingly, in view of the foregoing and without limitation on the range of instruction set designs; loop constructs; fetch buffer or instruction cache configurations; or underlying processor or system architectures that may be employed in embodiments of the present invention, we describe certain illustrative embodiments.

### Systems and Integrated Circuit Realizations, Generally

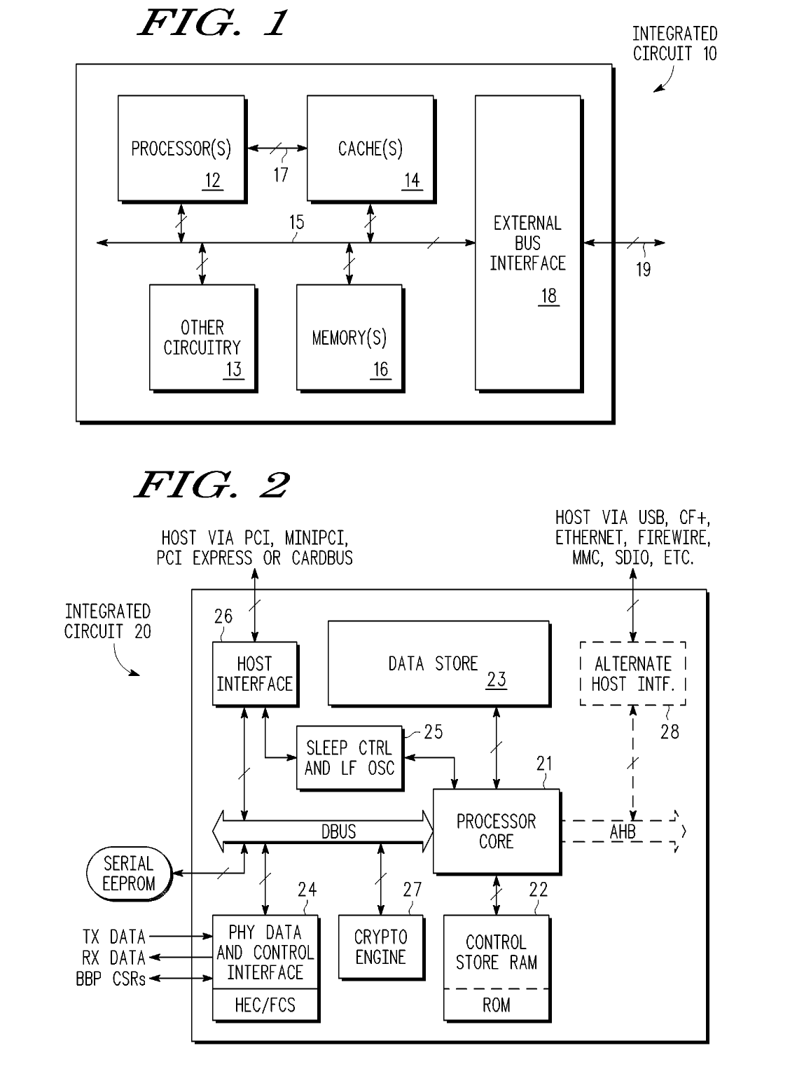

FIGS. 1 and 2 are respective block diagrams of a general purpose data processing system and a somewhat more specialized, embedded processor-type data processing system, each in accord with some embodiments of the present invention. FIG. 1 shows an information processing configuration that includes processor(s) 12, cache(s) 14, memory(s) 16, an external bus interface 18 and other circuitry 13. In the illustrated configuration, the aforementioned components are together embodied as exemplary integrated circuit 10; however, in other embodiments one or more components may be implemented in separate integrated circuits. Internal components of illustrated integrated circuit 10 are interconnected and interoperate using any suitable techniques. For simplicity, we illustrate interconnection amongst major functional blocks via bus 15, although persons of ordinary skill in the art will recognize that any of a variety of interconnection techniques and topologies may be employed without departing from the present invention. In general, integrated circuit 10 may interface to external components via external bus 19 or using other suitable interfaces.

Processor(s) 12 are of any type in which looping and instruction fetch behaviors are supported based on execution of code that includes loop-delimiting instructions. Typically, implementations of processor(s) 12 include a fetch buffer or other facility (such as an instruction cache) for storing instructions to be executed by the processor(s), decoder and sequencing logic, one or more execution units, and register storage, together with suitable data, instruction and control paths. At any given time, consistent with a computation performed by processor(s) 12, units of program code (e.g., instructions) and data reside in memory(s) 16, cache(s) 14 and/or processor stores (such as the fetch buffer, registers, etc.) In general, any of a variety of hierarchies may be employed, including designs that separate or commingle instructions and data in memory or cache. In addition, although FIG. 1 shows separate memory(s) 16 and cache(s) 14, other realizations consistent with the present invention may include one, but not the other, or may combine two or more levels of a memory hierarchy into one element or block. Processor facilities, e.g., logic, suitable for providing looping and instruction fetch behaviors are described below.

FIG. 2 shows an embedded processor-type information processing configuration that includes a processor core 21, together with a control store 22, a data store 23 and various illustrative data and control flow paths. As before, support for looping and instruction fetch behaviors is typically provided within processor circuits (here, processor core 21) and is described in greater detail below. Also as before, the components are illustrated together as exemplary integrated circuit 20; however, in other embodiments, one or more components may be implemented in separate integrated circuits. In contrast with the illustration of FIG. 1, FIG. 2 illustrates architectural features more commonly associated with some real-time, embedded-type architectures. Note that the features and architecture illustrated in FIG. 2 are not essential to any particular realization of the inventive techniques. Nonetheless, FIG. 2 and, in general, architectural features of typical real-time, embedded-type processor designs do provide a useful context in which to describe our techniques.

Internal components of illustrated integrated circuit 20 are interconnected and interoperate using any suitable techniques. For simplicity, we illustrate interconnection amongst major functional blocks via a bus DBUS and separate dedicated pathways (e.g., busses) for transfer of data to/from a local data store 23 and for fetching instructions from a local control store 22. That said, persons of ordinary skill in the art will recognize that any of a variety of interconnection techniques and topologies may be employed. In general, integrated circuit 20 may interface with external components (e.g., a host processor or system), transmit/receive circuits, event sources, input output devices, etc., via external buses or using other suitable interfaces.

In the illustration of FIG. 2, an embedded processor-type data processing system is configured for use as media access controller suitable for use in a wireless (e.g., 802.11n) station adapter. Of course, techniques of the present invention are not limited thereto. In the illustrated configuration, an interface 24 (PHY data and control) to transmit and receive circuits is provided together with a dedicated cryptographic engine 27 (or processor), timing/oscillator circuits 25 and interface(s) 26, 28 to one or more hosts. Typically, implementations of processor core 21 include one or more fetch buffers or other facilities for storing instructions to be executed by one or more execution units of the core, decoder and sequence control logic, timer and event handling logic, and register storage, together with suitable data, instruction and control paths. In some implementations, fetch buffers are associated with respective threads or active contexts.

At any given time, consistent with a computation performed, units of program code (e.g., instructions) reside in control store 22 and units of data reside in data store 23 and/or in stores provided within processor core 21 (such as context-specific fetch buffers, registers, etc.) In general, configuration of FIG. 2 maintains a “Harvard-architecture” style separation of instructions and data, although other approaches and other storage hierarchies may be employed, if desired. Processor facilities, e.g., logic, suitable for providing looping and instruction fetch behaviors are described below.

Consistent with a wireless MAC protocol controller application, the embedded-type data processing system illustrated in FIG. 2 includes features selected for efficient implementation of event-driven, real-time code for applications. Although techniques of the present invention may be exploited in any of a variety processor designs or architectures (embedded-type or otherwise) and, based on the description herein, persons of ordinary skill in the art will appreciate the richness of design variations, certain aspects of an illustrative embedded processor instance are described for concreteness.

### Switch On Event Multi-Threading (SOEMT), as an Example

Design choices made in at least some processor and integrated circuit implementations may deemphasize or eliminate the use of priority interrupts more commonly employed in conventional general purpose processor designs and instead, treat real-time (exogenous and endogenous) conditions as events. For example, in some implementations, assertion of an (enabled) event activates a corresponding one of multiple execution contexts, where each such context has (or can be viewed as having) its own program counter, fetch buffer and a set of programmer-visible registers. Contexts then compete for execution cycles using prioritized, preemptive multithreading, sometimes called “Switch-On-Event MultiThreading” (SOEMT). In some implementations, context switching occurs under hardware control with zero overhead cycles.

Generally, an instruction that has been issued will complete its execution, even if a context switch occurs while that instruction is still in the execution pipeline. In an illustrative SOEMT processor implementation, once a context is activated, the activated code runs to completion (subject to delays due to preemption by higher-priority contexts). If another of the context's events is asserted while the context is active to handle a previous event, handling of the second event occurs immediately after the running event handler terminates.

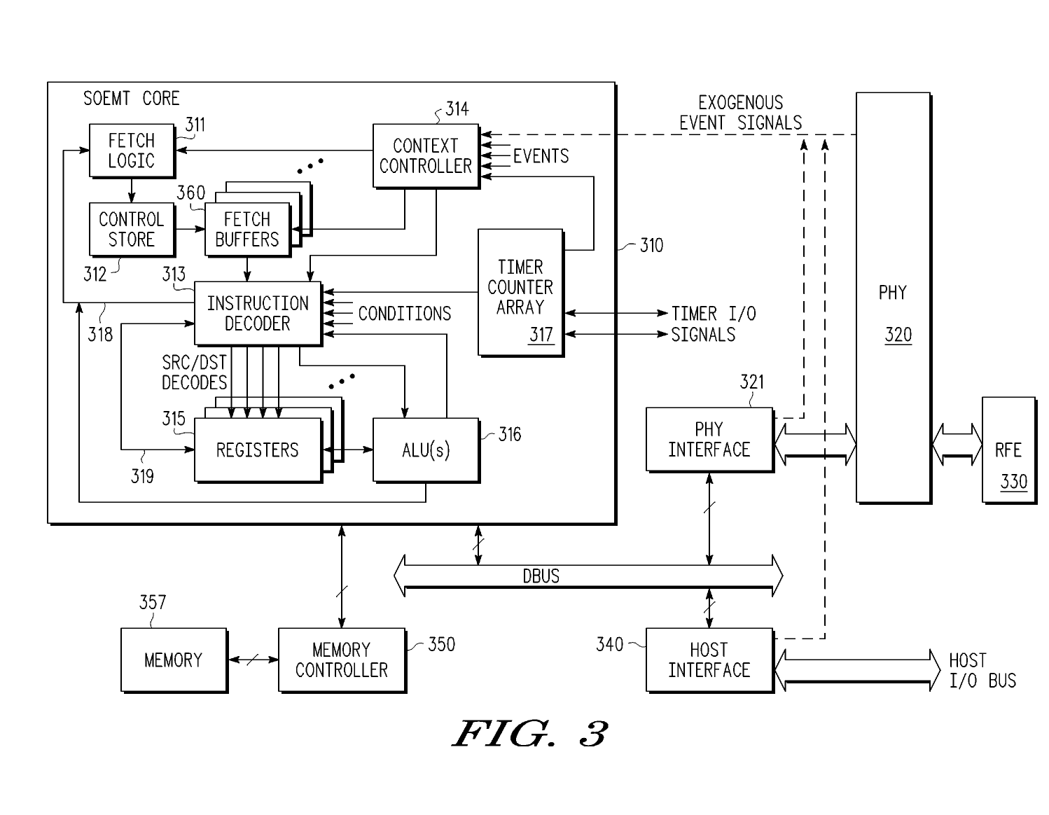

FIG. 3 is a block diagram that illustrates functional units of a switch on event multithreading (SOEMT) type embedded processor-based system in which techniques in accord with the present invention may be practiced and illustrated. In particular, FIG. 3 illustrates an SOEMT core 310 that includes one or more arithmetic logic units, ALU(s) 316, that execute(s) instructions fetched from control store 312 and decoded by instruction decoder 313. In the illustration, instruction decoder 313 is selective for source and/or destination register targets (in registers 315) of instructions decoded by instruction decoder 313. Registers 315 may include register sets separately maintained for each context executed by core 310 as well as registers whose state is shared amongst two or more contexts. As illustrated by flow 319, register state may, in some cases, affect operation of instruction decoder 313. For example, in some implementations consistent with FIG. 3, a block of context registers defined or definable within registers 315 implement a return stack onto which return addresses are pushed in connection with calls (including e.g., lightweight procedure calls and conventional C-style call sequences) and from which next program counter (next PC) values are popped in connection with returns. In some embodiments in accordance with the present invention, loop start addresses are pushed onto, retrieved from and popped from the return stack in connection with BEGIN and LOOP instruction executions as described herein.

Note that return addresses and loop start addresses need not be commingled in a single stack-type structure. Indeed, in some embodiments, storage for the loop start address may be provided by a separate register or (to support nesting) by a group of registers. In general, storage (whether organized as a stack or in accord with some other data organization) may be implemented in dedicated, shared, allocable and/or context- or thread-specific hardware or as a similar, in-memory structure. In some embodiments, a logical stack may be represented partly in register storage and partly in memory. For example, a top element of the stack may be maintained in a hardware register, while software manages storage by (i) saving register contents into an appropriate location in memory when another return/loop address is to be pushed and (ii) restoring to the register from the memory after consumption of an address from top of stack. In some embodiments, a design that employs multiple context-specific instances of a hardware register stack in which return addresses and loop start addresses are commingled may be desirable as processor logic and data paths that exist to push a next instruction address onto a stack (in connection with a call instruction) may be used to implement the BEGIN instruction. Similarly, to support the LOOP instruction and iterative behaviors described herein, extensions to return logic can selectively allow an address to be copied (rather than popped) from top of stack via a data path to the PC store that may already exist to support call return-related control transfers. Likewise, a pop and discard option can allow the return logic to handle the loop exit case of the LOOP instruction as described herein. Based on the description and claims herein, persons of ordinary skill in the art will appreciate a wide variety of suitable implementations for loop start address storage for BEGIN and LOOP instruction operations.

FIG. 3 includes fetch logic 311 and a context controller 314. Fetch logic 311 retrieves instructions (for at least the currently executing context(s)) from control store 312 in accordance with an execution order and in such a way that, at any given time, a small current subset of instructions reside in fetch buffers 360. These instructions are available for decoding by instruction decoder 313 and execution on ALU(s) 316. In the illustration of FIG. 3, fetch buffers 360 are organized as a set of per-context fetch buffers wherein constituent per-context portions contain relevant subsets of corresponding thread-sequences of instructions for presentation to instruction decoder 313 when a corresponding context is executing.

Note that, while the illustrated SOEMT-type processor core implementation provides hardware support for multiple active contexts including context-specific portions of fetch buffers 360 and registers 315, other embodiments need not implement the sample multithreaded execution model and/or may support differing allocations of fetch buffer and register resources. Nonetheless, in the interest of concreteness, we illustrate certain embodiments in view of structures and terminology appropriate to the illustrated SOEMT-type processor core. Based on the description herein, persons of ordinary skill in the art will appreciate variations and/or simplifications for other embodiments.

Referring to FIG. 3, responsive to activation events, context controller 314 preempts one or more executing context(s) in accord with a prioritization of contexts and mapping of activation events thereto. As illustrated in FIG. 3, activation events may be exogenous, such as events supplied via a physical layer data and control interface (PHY) 320 based on radio front end (RFE) 330 activity, I/O events or signals, or may be generated internally within the core itself, e.g., as a result of the computations performed by one or more contexts executed on core 310. Furthermore, as illustrated by flow 318, fetch logic 311 (and in particular the set of instructions maintained in fetch buffers 360) may be responsive to instruction decoder 313 such as in the case of a BEGIN instruction that, when decoded, unambiguously establishes that the next instruction address is the start of a loop body. In such case, flow 318 directs fetch logic 311 to maintain at least that start of a loop instruction in an appropriate one of fetch buffers 360. In some embodiments, such a directive may extend to (or as a practical matter may also) maintain one or more subsequent instructions of the loop body in fetch buffers 360. In some embodiments, subsequent instructions (e.g., those beyond a fetch group in which the start of a loop instruction appears) may ordinarily be made available to instruction decoder 313 based simply on a general, sequential fetch strategy implemented by fetch logic 311.

Note that, while some instruction set codings explained herein with respect to certain illustrative embodiments tend to assume a single instruction position displacement between a BEGIN instruction and the loop start address, persons of ordinary skill in the art will appreciate that other displacements may be appropriate in other embodiments. For example, other displacements may be desirable or acceptable in some embodiments. In general, loop body coding density may be improved if the BEGIN instruction (or its analog) appears outside the loop body; nonetheless, in some embodiments it may be acceptable to code a loop delimiting instruction together with (or just following) an instruction or instruction grouping that begins the loop body.

Configurations and interconnection of memory controller 350, memory 357, host interface 340 and PHY 321 with SOEMT core 310 via the illustrated bus DBUS are purely illustrative. Indeed, based on the description herein, many variations will be appreciated by persons of ordinary skill in the art.

### Loop-Delimiting Instructions

Turning now to an illustrative instruction set, techniques have been developed to identify explicitly the beginning of a loop body and to code a conditional loop closing branch in ways that allow a processor implementation to manage efficiently an instruction fetch buffer and/or entries in an instruction cache. In general, useful exploitations of these techniques can be embodied in an instruction set architecture and in concrete implementations thereof (e.g., as microprocessor integrated circuit implementations of a computation machine), as well as in computer readable encodings of program code that employ execution sequences of machine instructions that include loop-delimiting instructions of the type(s) described herein. In general, such program code may be prepared by machine instruction level programmers or generated by a compiler or other transformative method from iteration constructs that appear in a source level language or other precursor form.

By way of example, a first loop delimiting instruction (canonically a BEGIN instruction) is executable on a computational machine to identify a “loop start address” in program code, to store that loop start address on a return stack (or in other suitable storage of the computational machine) and to direct fetch logic to take advantage of the identification by retaining in a fetch buffer or instruction cache the instruction(s) beginning at the loop start address. Typically, the loop start address is the address of an instruction that immediately follows, or is located at a predetermined offset from, the BEGIN instruction. In this way, an execution sequence of machine instructions that includes a BEGIN instruction and an associated loop body can avoid instruction fetch delays that might otherwise be incurred if, upon iteration (and backward branch to the loop start address), the instruction at the loop start address has been displaced from the fetch buffer or instruction cache. For some loops, e.g., inner loop bodies consisting of short linear sequences (without branches) well within the capacity of a fetch buffer or instruction cache, non-sequential fetch overheads may not be a significant problem. However, more generally, for loops of larger size or for execution trajectories that for some other reason (such as loops or call/return sequences nested within a loop body, embedded multi-way branches and/or switch/case statements) may tend to displace the instruction appearing at the loop start address from a fetch buffer or instruction cache, the techniques described herein provide a useful technique for deterministically avoiding non-sequential fetch overheads that may be incurred on iteration. Note that large loop bodies may be coded by a programmer or may result from in-lining of code, e.g., by an optimizing compiler, for one or more called functions.

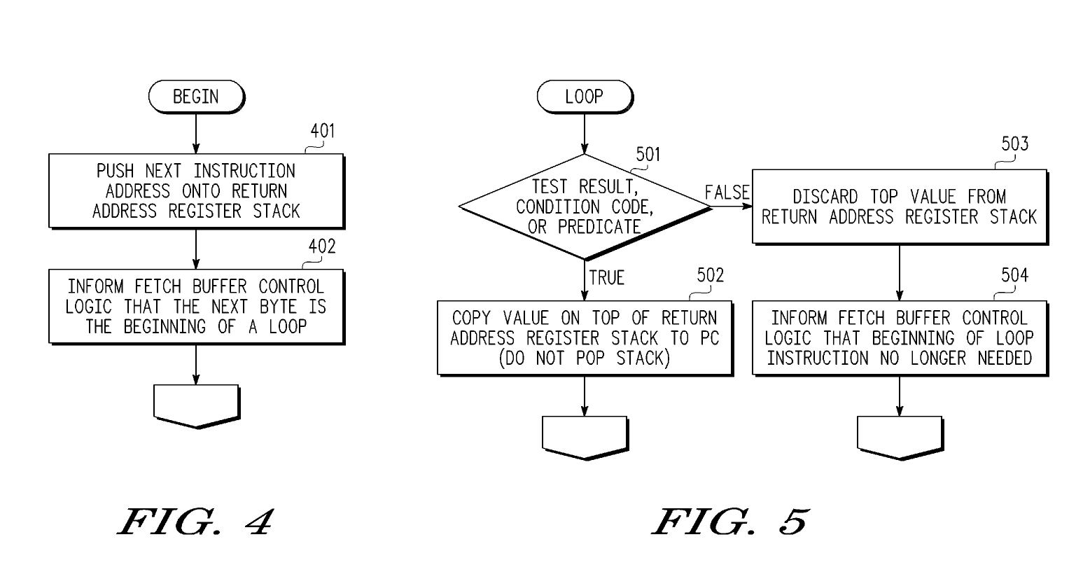

FIG. 4 illustrates operations performed by an illustrative processor upon execution of a BEGIN-type loop delimiting instruction such as described above. In particular, in response to identification of a BEGIN instruction (e.g., by instruction decoder 313, see FIG. 3), the processor pushes (401) a next instruction address onto a return address register stack (e.g., in registers 315, see FIG. 3). Thereafter or, in some embodiments, coincident with the push, the processor informs (402) instruction logic (e.g., fetch logic 311 operative to control contents of fetch buffer 318, see FIG. 3) that a corresponding machine instruction (e.g., a next entry) in fetch buffer 318, see FIG. 3, is at the beginning of a loop body and should be retained therein. Accordingly, as described above, execution of the BEGIN-type loop delimiting instruction provides the processor with a mechanism for deterministically avoiding non-sequential fetch overheads that may otherwise be incurred on iteration.

A second loop delimiting instruction (canonically a LOOP instruction) is executable on the computational machine to perform a specified condition test (or to test an appropriate condition code or predicate) and based on some results thereof (e.g., a true value) to iterate, while based on other results thereof (e.g., a false value) to exit. Of course, other codings and senses of loop continuation and loop exit conditions may be employed. More specifically, in the iterating case, the LOOP instruction initiates another pass through loop body code by copying to the program counter the loop start address which was previously stored on return stack (or in some other suitable storage) by a corresponding execution of the BEGIN instruction. In this way, the LOOP instruction need not expend coding space in the loop body to encode a branch target address or offset field. Furthermore, since the loop start address is not coded in the machine code itself, even a full instruction pointer width address can be used (without adversely affecting code density), and the extent of loop body code need not be limited, except by the address space of the computational machine. Such flexibility is in contrast with constraints typical of conventional instruction set approaches that seek to encode an address target in a small (e.g., 8-bit) offset field of a conditional branch instruction coding. In the exiting case, the LOOP instruction discards the previously stored loop start address and indicates to fetch logic that the instruction(s) previously retained beginning at the loop start address need not be retained in the fetch buffer or instruction cache for near-term re-execution.

FIG. 5 illustrates operations performed by an illustrative processor upon execution of a LOOP-type loop delimiting instruction such as described above. In particular, in response to identification of a LOOP instruction (e.g., by instruction decoder 313, see FIG. 3), the processor tests (501) a result, condition code, predicate, etc. In one case (the true case) the processor effectuates a loop closing branch by copying (502) the value (i.e., the loop start address) previously pushed onto and now residing at top of the return address register stack (e.g., in registers 315, see FIG. 3) to the program counter. Notably, true case operation of the LOOP instruction does not pop the loop start address from the return address register stack, but rather leaves the loop start address in place to serve (if appropriate) as the loop closing branch target in a next iteration. On the other hand, in the false case, operation of the LOOP instruction causes the processor to discard (503) the loop start address previously pushed (by a corresponding execution of the BEGIN instruction) onto the return address register stack (e.g., in registers 315, see FIG. 3) and now residing at top thereof. Typically, discard can be effectuated by a pop operation; however, any of a variety of discard mechanism consistent with semantics of the stack (or other store) may be employed in a given implementation. Thereafter or, in some embodiments, coincident with the discard, the processor informs (504) instruction logic (e.g., fetch logic 311 operative to control contents of fetch buffer 318, see FIG. 3) that a machine instruction (e.g., opcode byte or fetch group) in fetch buffer 318, see FIG. 3, corresponding to the now (or soon to be) discarded loop start address no longer needs to be retained in the fetch buffer or instruction cache for near-term re-execution.

In general, test and branch logic consistent with the above-described operation the LOOP instruction may be implemented in any appropriate place (including e.g., in a branch unit of ALU(s) 316, see FIG. 3). However, due in part to the absence of some execution steps conventionally performed by a loop closing branch (e.g., branch target extraction from an instruction register and/or address arithmetic), in some embodiments, at least some of the test and branch logic may optionally be implemented in a preceding pipeline stage.

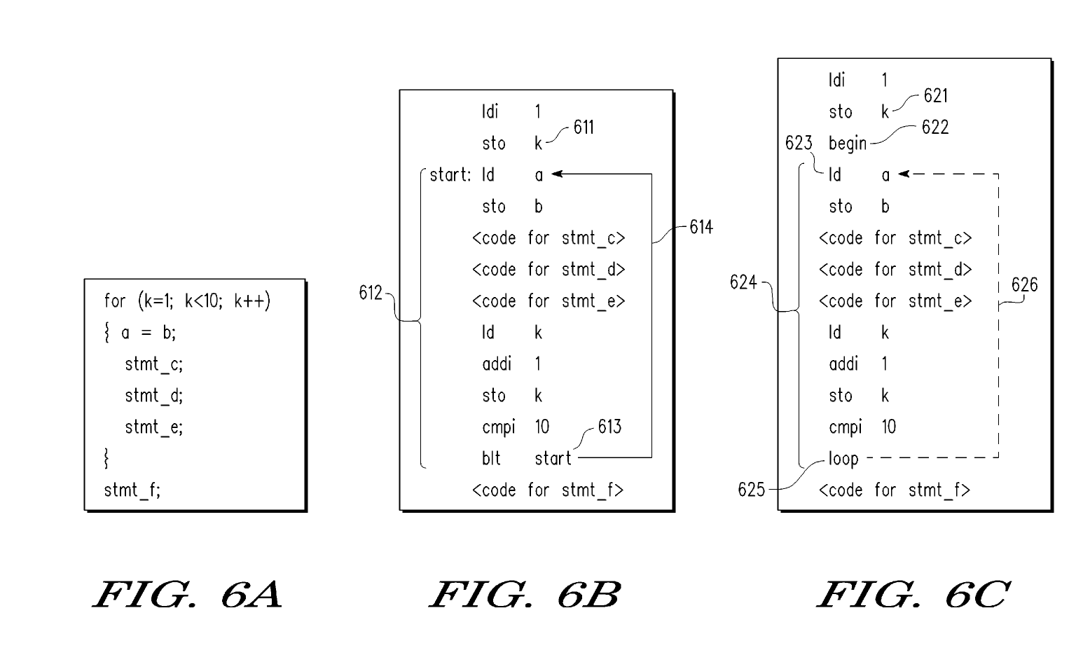

FIGS. 6A, 6B and 6C show loop containing code snippets illustrated in a way that highlights operation of some embodiments of the present invention and contrasts certain conventional approaches. In particular, FIG. 6A illustrates, in a form generally in accord with C-language syntax, a code snippet typical of source-level code that implements a for loop. The for loop executes nine iterations and includes four source-level statements (a=b; . . . stmt_e;) as a source-level loop body and a statement (stmt_f;) that follows the loop. FIGS. 6B and 6C then illustrate machine language implementations of loops that corresponds to the source level illustration of FIG. 6A. In each case, the corresponding machine code may be prepared using any suitable mechanism or technique including, without limitation, compilation and/or hand coding.

The illustration of FIG. 6B is largely conventional in that, after initialization of the loop index k (at instruction 611), execution drops directly into loop body 612, the beginning of which is generally identifiable (at runtime) by an address or offset denoted in the illustrated machine code using the label start. After machine instructions that implement the source-level loop body described with reference to FIG. 6A, the loop index k is incremented, compared to the loop limit of 10 and, in cases where the loop index k remains less than the loop limit, the code branches backwards (614) to a target identified (at runtime) by the address or offset corresponding to the label start. Note that (as is conventional) a memory address or offset (corresponding to the label start) is directly instantiated into actual machine code (e.g., by a compiler code generator, linker or runtime loader) in accord with the particular runtime placement of the loop code in addressable memory and whether the instruction set encodes conditional branch targets using absolute or relative addresses. Once the loop index k is incremented to a value that is no longer less than the loop limit, execution falls through loop closing conditional branch instruction 613 and continues with code for stmt_f.

In a conventional RISC instruction set implementation, the loop closing branch requires 32-bits. Even in a high-code density RISC implementation such as THUMB, MIPS-16, or Tensilica, the loop closing branch can require 16 or 24 bits (with 8-16 bits allocated to specification of the branch target). In addition, because backward branch 614 conditionally breaks an address-sequential program sequence, in those cases where the extent of loop body 612 exceeds capacity of a fetch buffer or execution of the loop body overwrites contents of relevant lines of the processor's instruction cache, a processor executing the code of FIG. 6B may experience a pipeline stall due at least in part to fetch overhead incurred for the non-sequential trajectory of backward branch 614. Although modern branch prediction techniques can hide or, at least, reduce non-sequential fetch overheads in many cases, branch prediction may introduce a non-deterministic factor not particularly compatible with requirements of embedded, real-time systems. Branch prediction can also be somewhat complex to implement in practice.

In contrast, FIG. 6C illustrates a machine language implementation that uses BEGIN-type and LOOP-type loop delimiting instructions in accordance with some embodiments of the present invention. As before, the machine language of FIG. 6C corresponds to the source-level loop described above with reference to FIG. 6A. However, unlike the machine code of FIG. 6B, after initialization of the loop index k (here, at instruction 621), a BEGIN instruction instance 622 serves to identify the next instruction (i.e., instruction 623) as the start of loop body 624. As previously described, the BEGIN instruction not only identifies a next instruction address as a “loop start address,” but also causes the processor on which it executes to store that loop start address on a return stack (or in other suitable storage) and directs fetch logic to take advantage of the identification by retaining in a fetch buffer or instruction cache at least the instruction (here instruction 623) at the loop start address.

After machine instructions that implement the source-level loop body described with reference to FIG. 6A, the loop index k is incremented, compared to the loop limit of 10 and, in cases where the loop index k remains less than the loop limit, the code branches backwards (626) to a target identified by the loop start address stored on the return stack. Note that, as previously described, the LOOP instruction instance (here, loop instruction 625), tests the loop exit condition (here, a value in a condition code register resulting after the compare instruction that precedes it) and, in one case (the true case) effectuates a loop closing branch by copying the loop start address to the program counter, while in another case (the false case corresponding to loop index k≧10), discards the loop start address previously stored (by execution of BEGIN instruction 622) and indicates (to a fetch buffer or instruction cache) that instruction 623, which corresponds to the now discarded loop start address, no longer needs to be retained for near-term re-execution. In the false case, execution falls through the LOOP instruction 625 and continues with code for stmt_f.

Although the code snippet of FIG. 6C shows explicit instructions within loop body 624, and it is those instructions that increment index k and compare k to the loop limit, other code formulations and LOOP instruction semantics are possible and will be appreciated by persons of ordinary skill in the art based on the description herein. For example, in some embodiments, operation of a LOOP instruction can be extended so that execution of the LOOP instruction causes a processor to increment (or decrement) a loop index and to compare same against the loop limit (or otherwise test a loop continuation/exit predicate).

Note that, in contrast with the loop closing branch and in-loop-body coding of branch target illustrated in FIG. 6B, the loop closing in FIG. 6C is efficiently coded within loop body 624 using just the LOOP instruction 625 and without any in-loop body coding of the branch target. In some implementations in accordance with the present invention the loop closing may be compactly coded in a mere 8 bits, and in some programs and/or situations, this compact coding can reduce the number of instruction bytes or words that need to be fetched to execute the loop below a threshold level necessary to guarantee that all instructions of the loop body reside in a fetch buffer or instruction cache. Notably, in the illustration of FIG. 6C, the ability to achieve such high coding densities is generally independent of loop size since a full instruction pointer-width branch target may be determined (implicitly) by a processor executing BEGIN instruction 622, stored on the return stack, and used by LOOP instruction 625, all without adversely impacting code density.

### Operation of an Example SOEMT Processor

For an SOEMT processor implementation that employs the techniques described herein, advantages can be significant. For example, in a network or communications controller implementation, tighter loops and reduced fetch latencies can allow a higher symbol rate to operating frequency ratio. Accordingly, in some designs, it is possible to achieve a target symbol rate at lower operating frequency and with lower power consumption. Conversely, in some designs, it can be possible to achieve higher symbol rates at a given operating frequency and/or power budget.

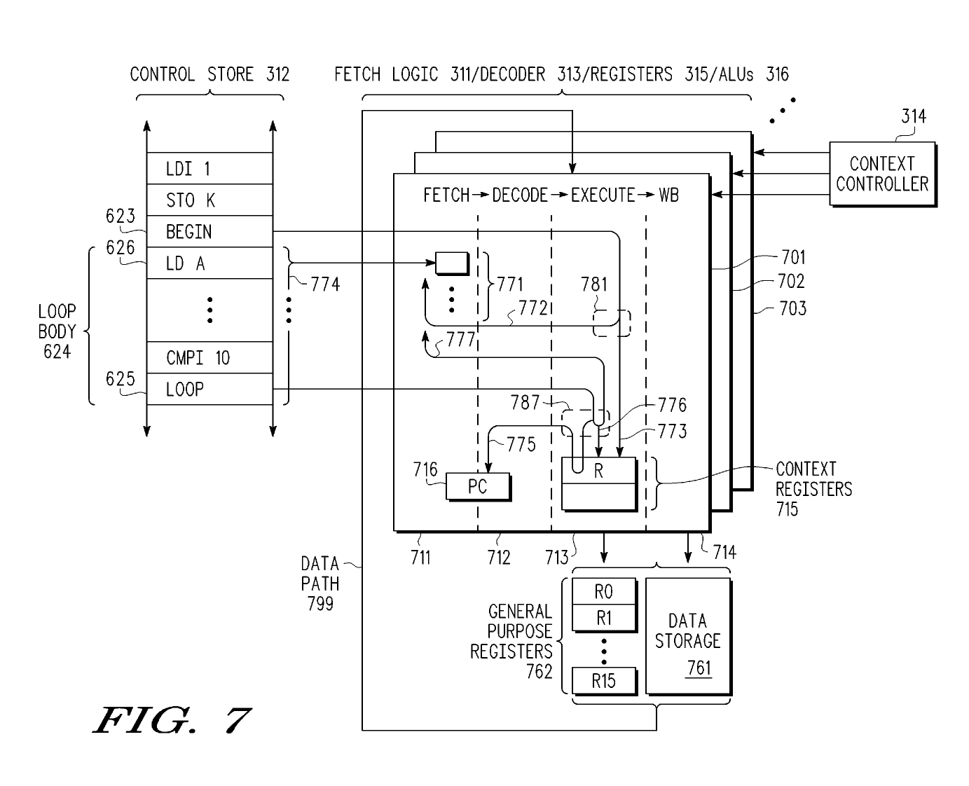

FIG. 7 illustrates selected elements of a processor core, e.g., that previously introduced as SOEMT embedded core 310 (recall FIG. 3) and its constituent elements, fetch logic 311, decoder 313, registers 315, ALU(s) 316, to support (consistent with an SOEMT execution model) activation, preemption and resumption of a various execution contexts 601, 602, 603, . . . under control of context controller 314. Fetch 711, decode 712, execute 713 and write back 714 stages of a pipeline are illustrated relative to an instruction sequence that includes a loop, such as previously described, being executed from control store 312 by the processor core. A data path 799 for the currently executing context 701 includes architectural registers 762 and/or data storage 761 such as memory. Of course, pipeline and data path design are purely illustrative and, based on the description herein, persons of ordinary skill in the art will appreciate adaptations for other designs.

In the illustrated instruction sequence, execution (781) of a first loop delimiting instruction (BEGIN instruction 623) pushes (773) an instruction pointer onto a return stack R which is represented (at least partially) in storage provided by context registers 715. Note that, in general, return stack R may be implemented in hardware, e.g., as a physical register or memory stack, or may be implemented in software with a top-of-stack register maintained in hardware and push/pop activity performed by software. Nonetheless, for simplicity and clarity of illustration, physical register storage is presumed. The instruction pointer identifies the first instruction of loop body 624 (here, LD instruction 626) and serves as the loop closing branch target for a subsequently executed instance of the LOOP instruction. Execution (781) of BEGIN instruction 623 also directs (772) fetch logic 311 to maintain the identified first instruction of loop body 624 in a fetch buffer 771. In the illustrated embodiment, fetch buffer 771 is associated with currently executing context 701, although other multi-threaded processor embodiments may share a fetch buffer or instruction cache amongst executing contexts, in which case, directive (772) would apply to the shared fetch buffer or instruction cache. Note that, depending on the implementation, such a directive may cover (774) LD instruction 626 itself or a fetch group of instructions that includes LD instruction 626 or may extend to a larger set of instructions (or fetch groups) that may (in some cases) cover the entirety of loop body 624.

Execution (782) of a corresponding instance of the second loop delimiting instruction (LOOP instruction 625) determines, based on a condition code established by the compare instruction (CMPI 10) that precedes it, whether the execution sequence branches backward to the first instruction of loop body 624 or falls through to the instruction that follows. Note that, more generally, any of a variety of predicates, values and/or condition codes may be evaluated in the course of executing a LOOP-type instruction and semantics of any LOOP instruction (or variant thereof) are implementation dependent.

In the first case (iteration/backward branch), LOOP instruction 625 copies (775) to program counter 716 the instruction pointer corresponding to the first instruction of loop body 624 (here, LD instruction 626), which was previously pushed (773) onto a return stack R (in storage provided by context registers 715) by execution (781) of BEGIN instruction 623. Note that, in some embodiments, return address pointers are also pushed onto return stack R in connection with CALL-type instructions and then popped and used to update program counter 716 in accordance with a RETURN-type instruction. Indeed, in some embodiments, loop start addresses and return addresses are commingled in return stack R and some shared resources are used to support execution of the BEGIN and CALL instructions (on the one hand) and LOOP and RETURN instructions on the other hand. However, unlike a RETURN instruction, iterating executions of LOOP instruction 625 leave the previously pushed (773) loop start address at the top of return stack R for potential reuse in a subsequent iteration.

In the second case (loop exit/fall through), execution (782) of LOOP instruction 625 pops (776) the previously pushed (773) loop start address from the top of return stack R and the value in program counter 716 increments normally, allowing the execution sequence to exit loop body 624. Finally, in the second case (loop exit/fall through), execution (782) of LOOP instruction 625 rescinds (777) the prior directive (772) that fetch logic 311 maintain the identified first instruction of loop body 624 in a fetch buffer 771.

Although the illustration of FIG. 7 generally illustrates operations performed in an execute stage (713) of a pipeline, typically together with effects on resources employed at other stages (e.g., at fetch stage 711, decode stage 712 or execute stage 713), persons of ordinary skill in the art will recognize that pipeline stages are largely implementation dependent. Indeed, given the semantics of BEGIN and LOOP instructions described, conventional execution steps such as address arithmetic and/or extraction of a branch target address from an instruction register need not be performed. Accordingly, in some embodiments, loop start address determinations and/or loop closing updates to a program counter may be performed or initiated at an earlier pipeline stage if desirable or convenient. Accordingly, the allocation of functionality to pipeline stages shown in FIG. 7 is merely illustrative and persons of ordinary skill in the art will appreciate alternative allocations suitable for a given implementation.

While the illustration of FIG. 7 focuses on a currently executing context 701, it should be understood that the other contexts amongst which context controller 314 switches may, and likely will, also execute of program code that includes BEGIN and LOOP instruction delimited loops. Accordingly, respective instances of the described structures and techniques may be operant at any given time in two or more of the illustrated contexts. In addition, while FIG. 7 illustrates techniques in accordance with the present invention using a single BEGIN/LOOP delimited loop construct and without additional internal control transfers, persons of ordinary skill in the art will appreciate that nesting of additional loops (whether BEGIN and LOOP instruction delimited or otherwise) and inclusion of branch constructs internal to the illustrated loop body may both be supported using the return address stack techniques described above.

In general, techniques in accordance with the present invention can allow arbitrary levels of nesting of return addresses. However, in actual practice, there may not be a corresponding ability to retain an arbitrary number of loop start instructions in a fetch buffer. However, even given such practical constraints, one suitable strategy for nested BEGIN/LOOP constructs is to retain only the N (where N>=1) most recent loop start instructions, based on the fact that these are the innermost loops, which (necessarily) need their loop start instruction addresses more frequently than the enclosing loops. Although the consequence of discarding a retained loop start instruction address for an outer loop is the extra time to perform the non-sequential instruction fetch, the loop executes properly whether or not the initial instruction is retained.

### OTHER EMBODIMENTS

Although the invention is described herein with reference to specific embodiments, various modifications and changes can be made without departing from the scope of the present invention as set forth in the claims below. For example, while techniques have been described that allow certain embedded-type processor implementations to limit non-deterministic fetch overheads that may otherwise be incurred in some iterations of a loop construct, the described techniques have broad applicability to a variety of processor types and implementations. Similarly, although the described techniques may be employed to facilitate high density codings of machine code and thereby support high symbol rate to operating frequency ratios desirable for communications processors, the techniques are not limited thereto.

Embodiments of the present invention may be implemented using any of a variety of different information processing systems. Accordingly, while FIGS. 1 and 2, together with their accompanying description relate to exemplary general purpose and embedded processor-type information processing architectures, these exemplary architectures are merely illustrative. More particularly, although SOEMT-type processor designs (FIG. 3) provide a useful context in which to illustrate our techniques, processors without SOEMT characteristics are envisioned and described. Of course, architectural descriptions herein have been simplified for purposes of discussion and those skilled in the art will recognize that illustrated boundaries between logic blocks or components are merely illustrative and that alternative embodiments may merge logic blocks or circuit elements and/or impose an alternate decomposition of functionality upon various logic blocks or circuit elements.

Articles, system and apparati that implement the present invention are, for the most part, composed of electronic components, circuits and/or code (e.g., software, firmware and/or microcode) known to those skilled in the art and functionally described herein. Accordingly, component, circuit and code details are explained at a level of detail necessary for clarity, for concreteness and to facilitate an understanding and appreciation of the underlying concepts of the present invention. In some cases, a generalized description of features, structures, components or implementation techniques know in the art is used so as avoid obfuscation or distraction from the teachings of the present invention.

In general, the terms “program” and/or “program code” are used herein to describe a sequence or set of instructions designed for execution on a computer system. As such, such terms may include or encompass subroutines, functions, procedures, object methods, implementations of software methods, interfaces or objects, executable applications, applets, servlets, source, object or intermediate code, shared and/or dynamically loaded/linked libraries and/or other sequences or groups of instructions designed for execution on a computer system.

In some embodiments of the present invention, a computer program product is embodied in at least one computer readable medium and includes program code executable on a processor, wherein the program code includes a loop construct encoded using delimiting BEGIN- and LOOP-type instructions. All or some of the program code described herein, as well as any software implemented functionality of information processing systems described herein, may be accessed or received by elements of a information processing system, for example, from computer readable media or via other systems. In general, computer readable media may be permanently, removably or remotely coupled to an information processing system. Computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.; and media incident to data transmission including transmissions via computer networks, point-to-point telecommunication equipment, and carrier waves or signals, just to name a few.

Finally, the specification and figures are to be regarded in an illustrative rather than a restrictive sense, and consistent with the description herein, a broad range of variations, modifications and extensions are envisioned. Any benefits, advantages, or solutions to problems that are described herein with regard to specific embodiments are not intended to be construed as a critical, required, or essential feature or element of any or all the claims.

What is claimed is:

1. A method of operating a processor, the method comprising:
executing program code that includes a first loop coded as a loop body delimited using respective first- and second-type instructions executable by the processor;
the delimiting first-type instruction, when executed, causing the processor to store a corresponding loop start address in storage and to direct instruction fetch logic of the processor to retain in an instruction fetch buffer at least the instruction at the loop start address;
the delimiting second-type instruction, when executed, causing the processor to test a condition or predicate and, depending upon a result of the test, to either:
(i) update an instruction pointer to correspond to the loop start address in the storage or
(ii) terminate the first loop and effectively discard the loop start address from the storage.

2. The method of claim 1,
wherein coincident with the effective discarding, execution of the delimiting second-type instruction negates the prior directing to retain.

3. The method of claim 1,
wherein the directing to retain covers a fetch group of instructions that includes the instruction at the loop start address; and

4. The method of claim 1,
wherein the loop start address stored by execution of the delimiting first-type instruction is an instruction pointer width coding of an address for an instruction that follows at a predetermined fixed offset.

5. The method of claim 1,
wherein the loop start address is not explicitly coded by or with the delimiting first-type instruction.

6. The method of claim 1,
wherein the loop body of the executed program code includes at least a second, similarly-delimited loop nested therewithin.

7. The method of claim 1,
wherein the loop body of the executed program code is of a size greater than supported by any fixed-size loop mechanism implemented by the processor; and
wherein neither the first- nor second-type instructions encode an address or address offset.

8. The method of claim 1,
wherein the storage is organized as an address stack; and
wherein the address stack is implemented as a set of physical registers or as a logical stack based on one or more underlying physical registers and memory.

9. The method of claim 8, further comprising:
for at least a second, similarly-delimited loop nested within the first loop, pushing a corresponding second loop start address onto the address stack;
iterating the second loop using the second loop start address; and
coincident with termination of the second loop, discarding the second loop start address from top of the address stack.

10. The method of claim 8,
wherein the address stack is implemented as a return address stack that stores both loop start addresses and return addresses for at least a subset of procedure calls executed in accord with an operant trajectory of the program code.

11. The method of claim 10,
wherein the delimiting first-type instruction is implemented by the processor as a BEGIN instruction that pushes the loop start address onto the return address stack by modifying a return stack pointer, RSP, and storing an address of an instruction that next follows the BEGIN at top, R, of the return address stack; and
wherein the delimiting second-type instruction is implemented by the processor as a LOOP instruction that tests a register or operand value, T, to determine whether to repeat the loop body, wherein if T!=0, the LOOP instruction copies the loop start address at R to a program counter PC, without removing the loop start address from the return stack, and wherein if T=0, the LOOP instruction removes the loop start address from the return stack by modifying RSP, but does not modify the program counter PC, instead allowing execution of the program code to continue after the first loop with an instruction that appears at a next instruction address.

12. An apparatus comprising:
a processor including a fetch buffer and a return address stack,
the processor being responsive to instructions executed from the fetch buffer, wherein responsive to execution of a first BEGIN-type instruction instance, the processor pushes a first loop start address onto the return address stack, and wherein responsive to execution of a first LOOP-type instruction instance, the processor tests a value or predicate and based on a result thereof either (i) causes the processor to use as a next instruction address the first loop start address at top of the return address stack or (ii) effectively discards the first loop start address at top of the return address stack.

13. The apparatus of claim 12, further comprising:
fetch logic coupled to the fetch buffer for maintaining therein a subset of instructions obtained from a control store,
the fetch logic responsive to execution of BEGIN-type and LOOP-type instructions, wherein in response to the execution of the first BEGIN-type instruction instance, the fetch logic maintains in the fetch buffer at least a particular instruction at the first loop start address, and wherein in response to an execution of the first LOOP-type instruction instance that effectively discards the first loop start address, the fetch logic no longer maintains the particular instruction in the fetch buffer.

14. The apparatus of claim 12,
wherein a loop body delimited by the first BEGIN-type and LOOP-type instruction instances is of a size greater than supported by any fixed-size loop mechanism implemented by the processor; and
wherein neither the first BEGIN-type instruction instance nor the first LOOP-type instruction instance encodes an address or address offset.

15. The apparatus of claim 12,
wherein the address stack includes entries suitable for storage of one or more additional loop start addresses corresponding to one or more loops within which a loop body delimited by the first BEGIN-type and LOOP-type instruction instances is nested.

16. The apparatus of claim 12,
wherein the processor implements a switch on event multithreading (SOEMT) execution model whereby multiple concurrently active contexts are supported; and
wherein the processor includes additional fetch buffer and address stack instances, the additional instances corresponding to additional execution contexts that may be active in the SOEMT processor.

17. A method comprising:
from a source-form representation, preparing program code suitable for execution on a target processor,
the program code including a loop coded as a loop body delimited using respective first- and second-type machine instructions defined in accordance with an instruction set implemented by the target processor;
the delimiting first-type instruction directing the target processor to push a corresponding loop start address onto an address stack; and
the delimiting second-type instruction directing the target processor to test a condition or predicate, wherein for a first subset of results of the test, the delimiting second-type instruction directs the target processor to update an instruction pointer to correspond to the loop start address at top of the address stack, and wherein for a second subset of results distinct from the first, delimiting second-type instruction directs the target processor to pop the loop start address from the address stack and terminates the loop,
wherein neither the first-type instruction nor the second-type instruction explicitly encode the loop start address.

18. The method of claim 17,
wherein the first-type instruction further directs instruction fetch logic of the target processor to retain in an instruction fetch buffer a group of instructions that includes at least the instruction at the loop start address; and
wherein for the second subset of results, the delimiting second-type instruction negates the prior directing to retain.

19. The method of claim 17,
encoding the program code together with the loop body and delimiting first-type and second-type machine instructions in one or more computer readable media.

20. The method of claim 17,
executing the program code together with the loop body and delimiting first-type and second-type machine instructions on an implementation of the target processor.
